(19) United States
(12) Patent Application Publication
(10) Pub. No.: US 2007/0196714 A1
(43) Pub. Date: Aug. 23, 2007

(54) POLYMER MEMBRANE, METHOD OF PREPARING THE SAME AND FUEL CELL EMPLOYING THE SAME

(76) Inventors: Sang-kook Mah, Yongin-si (KR); Young-gyoon Ryu, Yongin-si (KR); Do-yun Kim, Yongin-si (KR); Jin-gyu Lee, Yongin-si (KR); Myung-sup Jung, Yongin-si (KR); Jae-jun Lee, Yongin-si (KR)

Correspondence Address: CHRISTIE, PARKER & HALE, LLP, PO BOX 7068, PASADENA, CA, 91109-7068, US

(21) Appl. No.: 11/677,950

(22) Filed: Feb. 22, 2007

(30) Foreign Application Priority Data
Feb. 23, 2006 (KR) 10-2006-0017877

(51) Int. Cl. H01M 8/10; C08J 5/22; C08K 5/00

(52) U.S. Cl. 429/33; 429/314; 521/27; 523/507

(57) ABSTRACT

A polymer membrane, a method of preparing the same, and a fuel cell employing the same are provided, where the polymer membrane includes a porous polymer film having sulfonated pores. The polymer membrane can be prepared easily and economically, has excellent ionic conductivity, and effectively reduces crossover in a fuel cell.

### CROSS-REFERENCE TO RELATED PATENT APPLICATION

This application claims priority to and the benefit of Korean Patent Application No. 10-2006-0017877, filed on Feb. 23, 2006, in the Korean Intellectual Property Office, the disclosure of which is incorporated herein in its entirety by reference.

### BACKGROUND OF THE INVENTION

1. Field of the Invention

The present invention relates to a polymer membrane, a method of preparing the same, and a fuel cell employing the same.

2. Description of the Related Art

Fuel cells are apparatuses which generate electrical energy through an electrochemical reaction between fuel and oxygen. Such fuel cells can be used as power sources for small electric/electronic devices, particularly portable devices, as well as for industrial, domestic, and transportation applications.

Fuel cells can be classified into polymer electrolyte membrane fuel cells (PEMFCs), phosphoric acid fuel cells (PAFCs), molten carbonate fuel cells (MCFCs), solid oxide fuel cells (SOFCs), and other types according to the type of electrolyte used. The working temperature of the fuel cells and their constituent materials vary according to the type of electrolyte used.

Fuel cells can also be classified into an external reformer type fuel cell in which fuel is supplied to the anode after being converted into a hydrogen-rich gas by an external reformer, and an internal reformer type fuel cell or direct fuel supply type fuel cell in which fuel in a gaseous or liquid state is directly supplied to the anode.

A representative example of a direct liquid fuel cell is a direct methanol fuel cell (DMFC). DMFCs use an aqueous methanol solution as fuel, and a proton exchange polymer membrane with ionic conductivity as an electrolyte. Accordingly, DMFCs are a type of PEMFC.

PEMFCs are small and lightweight, but can achieve a high energy density. In addition, an energy generating system having a simple structure can be manufactured using PEMFCs.

A basic PEMFC may include an anode (fuel electrode), a cathode (oxidizing agent electrode), and a polymer electrolyte membrane interposed between the anode and the cathode. The anode may include a catalyst layer to promote the oxidation of a fuel. The cathode may include a catalyst layer to promote the reduction of an oxidizing agent.

The fuel supplied to the anode may generally be hydrogen, a hydrogen-containing gas, a mixture of methanol vapor and water vapor, an aqueous methanol solution, etc. The oxidizing agent supplied to the cathode may generally be oxygen, an oxygen-containing gas, or air.

Fuel is oxidized to produce protons and electrons at the anode of the PEMFC. The protons migrate to the cathode through the electrolyte membrane and the electrons migrate to an external circuit (load) through a conductive wire (or current collector). The electrons are supplied to the cathode from the external circuit through another conductive wire (or current collector). At the cathode of the PEMFC, the protons react with the electrons and oxygen to produce water. The migration of electrons from the anode to the cathode via the external circuit generates electricity.

In a PEMFC, the polymer electrolyte membrane acts as an ionic conductor for the migration of protons from the anode to the cathode and also acts as a separator to prevent contact between the anode and the cathode. The polymer electrolyte membrane therefore requires sufficient ionic conductivity, electrochemical stability, high mechanical strength and thermal stability at its operating temperature, and thin layers of the polymer electrolyte membrane should be easily formed.

Generally, materials for forming the polymer electrolyte membrane include a sulfonated perfluorinated polymer with fluorinated alkylene in its backbone and fluorinated vinylether side chains with sulfonic acid at its terminal, for example, NAFION™, manufactured by DUPONT. The polymer electrolyte membrane absorbs an appropriate amount of water and provides excellent ionic conductivity.

The polymer electrolyte membrane has excellent ionic conductivity, but crossover of fuel is high due to the large diameter of a channel connected to an ionomer cluster. Also, the mechanical properties of a polymer electrolyte membrane may be bad, and thus, a fuel cell employing the polymer electrolyte membrane bends easily. Accordingly, the preparation of a fuel cell employing the polymer electrolyte membrane is difficult. Moreover, the polymer electrolyte membrane is expensive.

### SUMMARY OF THE INVENTION

Exemplary embodiments of the present invention provide a polymer membrane which can be prepared easily and economically, has excellent ionic conductivity, and effectively reduces crossover in a fuel cell, a method of preparing the same, and a fuel cell employing the same.

According to one embodiment of the present invention, a polymer membrane is provided, including a porous polymer film having sulfonated pores.

According to another embodiment of the present invention, a method of preparing a polymer membrane is provided, the method including: preparing a porous polymer film; impregnating the porous polymer film with a solution for sulfonation; and cleaning and drying the resultant porous polymer film.

According to another embodiment of the present invention, a fuel cell is provided, including: a cathode; an anode; and the polymer membrane described above disposed between the cathode and the anode.

### BRIEF DESCRIPTION OF THE DRAWINGS

FIG. 1 is a schematic diagram illustrating a method of preparing a porous polymer membrane having sulfonated pores by sulfonating the pores of the porous polymer membrane according to an embodiment of the present invention;

FIGS. 2A and 2B are schematic diagrams illustrating methods of preparing polymer membranes according to several embodiments of the present invention;

FIG. 3 is a schematic diagram of a fuel cell according to an embodiment of the present invention;

FIG. 4 is the infrared (IR) spectrum of porous polymer films prepared in Example 2 and Comparative Example 1; and

FIGS. 5A through 5C are scanning electron microscope photos of a porous polymer film before sulfuric acid solution treatment, a porous polymer film prepared in Example 2, and a porous polymer film prepared in Example 4, respectively.

### DETAILED DESCRIPTION

A polymer membrane according to an embodiment of the present invention includes a porous polymer film having sulfonated pores.

Generally, a sulfonated perfluorinated polymer (for example, NAFION manufactured by DuPont), or the like, which has excellent chemical stability and conductivity, is used to form a polymer electrolyte membrane in a fuel cell. However, a sulfonated perfluorinated polymer is very expensive, and has pores having a large diameter connected to ionomer clusters, allowing for high fuel crossover. Also, when the sulfonated perfluorinated polymer is used in a fuel cell, the sulfonated perfluorinated polymer bends easily.

The polymer membrane of the current embodiment solves such problems by sulfonating the pores of a low priced, porous polymer film to increase ionic conductivity and reduce crossover.

In one embodiment, the porous polymer film may be a porous polyolefin film, and in another embodiment, a porous polyethylene film, a porous polypropylene film, or a mixed film thereof, but is not limited thereto.

In one embodiment, the average diameter of the pores of the porous polymer film may be in the range of 10 nm to 10 μm. In another embodiment, the total volume of the pores of the porous polymer film may be in the range of 10 to 90% of the total volume of the porous polymer film. When the average diameter of the pores of the porous polymer film is less than 10 nm or when the total volume of the pores of the porous polymer film is less than 10% of the total volume of the porous polymer film, the pores cannot effectively be sulfonated. When the average diameter of the pores of the porous polymer film is greater than 10 μm or when the total volume of the pores of the porous polymer film is greater than 90% of the total volume of the porous polymer film, the mechanical properties of the porous polymer film deteriorate, and thus it is difficult to use the porous polymer film as an electrolyte membrane.

In an embodiment, the thickness of the polymer membrane may be in the range of 0.5 to 2,000 μm. When the thickness is less than 0.5 μm, it is difficult to prepare a porous polymer film. When the thickness is greater than 2,000 μm, the membrane resistance is too high.

Generally, as the ionic conductivity of a conventional material used as a polymer membrane for a fuel cell increases, permeability thereof also increases. The polymer membrane of the present invention has better ionic conductivity than a widely used conventional polymer membrane such as NAFION, but at the same time has lower permeability. Accordingly, the ratio of ionic conductivity to permeability, that is, ionic conductivity/permeability of the polymer membrane of the present invention is greater than or equal to the ratio of ionic conductivity to permeability of a conventional polymer membrane such as NAFION, etc.

The polymer membrane in one embodiment of the present invention has a structure in which a sulfonic acid group is directly connected to a carbon chain. Accordingly, when a carbon atom of the polymer membrane and the sulfonic acid group are connected, a mediator compound or group is not needed. Accordingly, the pores of the polymer membrane of the present invention can be sulfonated using a simple process.

The sulfonated pores may include an alkane sulfonic acid group of Formula 1, a beta-sulfone group of Formula 2, an alkene sulfonic acid group of Formula 3 or 4, a gamma-sulfone group of Formula 5, or a delta-sulfone group of Formula 6:

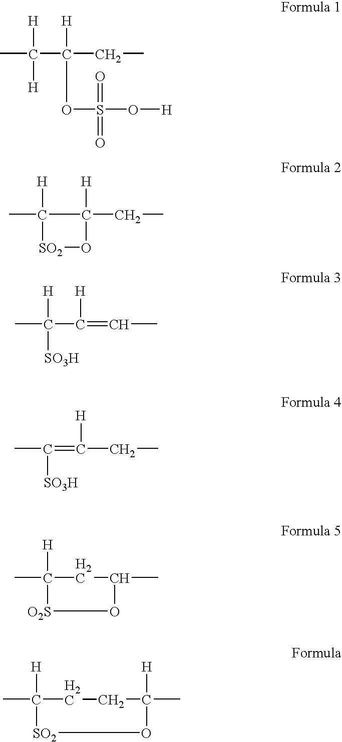

The polymer membrane of the present invention may further include an ionic conductive material coated on one or both sides of the porous polymer film to improve ionic conductivity or mechanical properties. In one embodiment, the ionic conductive material may be selected from the group consisting of sulfonated perfluorinated polymer, sulfonated polysulfone, sulfonated polystyrene, sulfonated polyetheretherketone, sulfonated polybenzimidazole, sulfonated polyimide, and sulfonated polyphosphazene, but is not limited thereto.

A method of preparing a polymer membrane according to an embodiment of the present invention includes preparing a porous polymer film, impregnating the porous polymer film with a solution for sulfonation, and cleaning and drying the resultant porous polymer film.

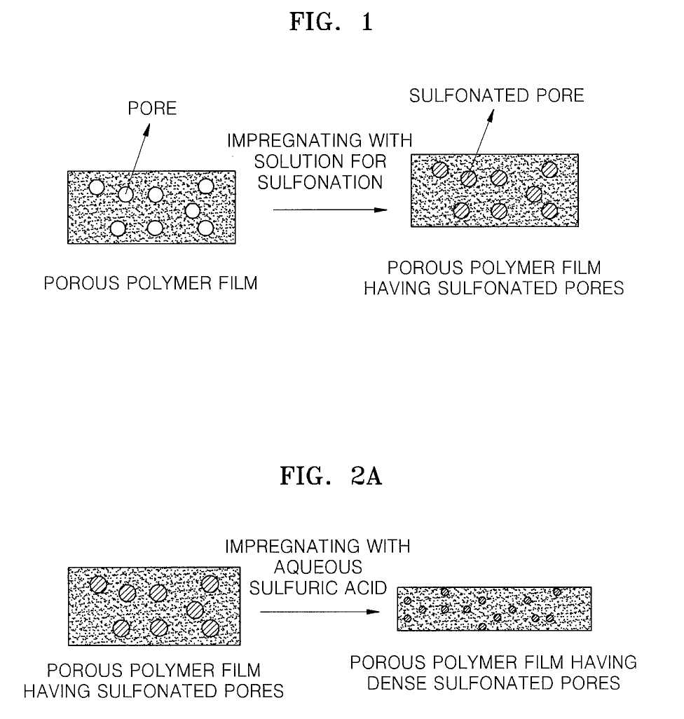

FIG. 1 is a schematic diagram illustrating a method of preparing a porous polymer membrane having sulfonated pores by sulfonating the pores of the porous polymer membrane according to the current embodiment of the present invention.

Referring to FIG. 1, the porous polymer film is prepared first. The porous polymer film, as described above, may be a porous polyolefin film such as a porous polyethylene film, a porous polypropylene film, or a mixed film thereof, but is not limited thereto. In one embodiment, the average diameter of the pores of the porous polymer film may be in the range of 10 nm to 10 μm. In another embodiment, the total volume of the pores of the porous polymer film may be in the range of 10 to 90% of the total volume of the porous polymer film.

In one embodiment, the solution for sulfonation is a solvent or a solution which can sulfonate the porous polymer film. Examples of the solution for sulfonation include sulfuric acid with a concentration of 90% or greater, fuming sulfuric acid, and chlorosulfonic acid, but are not limited thereto. For easy penetration of the solution for sulfonation into the pores, the solution for sulfonation may further include a supporting solvent selected from the group consisting of dichloromethane, dichloroethane, chloroform, or a mixture thereof.

In an embodiment, the amount of the solution for sulfonation may be in the range of 10 to 500 parts by weight based on 100 parts by weight of the supporting solvent.

In one embodiment, the impregnation of the porous polymer film with the solution for sulfonation may be performed at room temperature to 70° C. for 0.1 to 24 hours. When the temperature is lower than room temperature, sulfonation takes a long time. When the temperature is above 70° C., sulfonation time is too short to obtain reproducibility.

As shown in FIG. 1, the porous polymer film having sulfonated pores is prepared through the impregnation of the porous polymer film. Then, the porous polymer film having sulfonated pores is cleaned and dried to obtain the polymer membrane. The cleaning can be performed using deionized water, or the like.

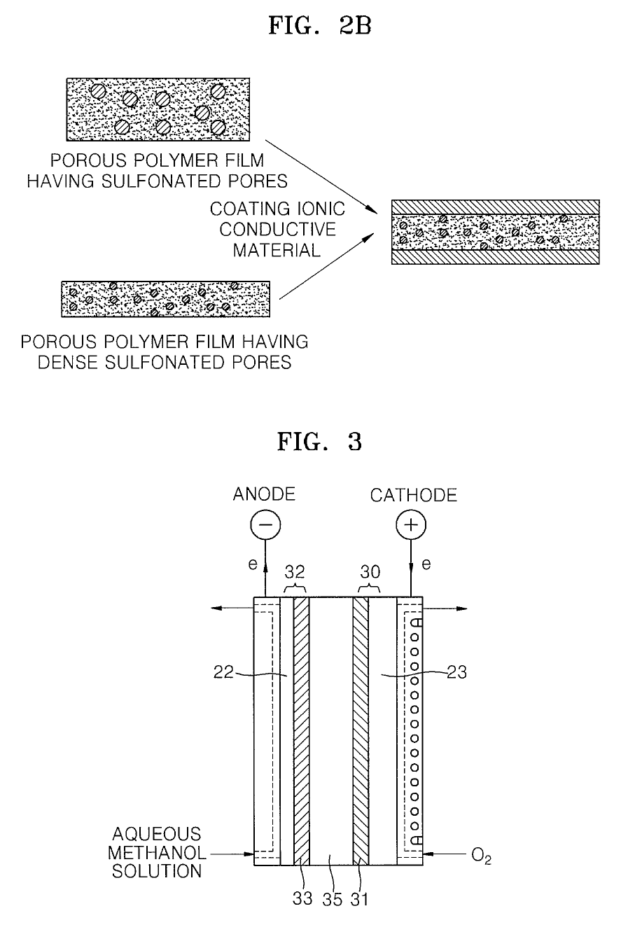

FIGS. 2A and 2B are schematic drawings illustrating methods of preparing polymer membranes according to several embodiments of the present invention. In FIG. 2A, the porous polymer film having sulfonated pores described above is impregnated with an aqueous sulfuric acid solution to prepare a porous polymer film having dense sulfonated pores. In FIG. 2B, an ionic conductive material is coated on the surface of the porous polymer film having sulfonated pores, or the surface of the porous polymer film having dense sulfonated pores, to prepare a porous polymer film having sulfonated pores with excellent ionic conductivity.

In an embodiment, the aqueous sulfuric acid solution may have a concentration of 30 to 50% and the impregnation with the aqueous sulfuric acid solution may be performed at room temperature.

A fuel cell according to an embodiment of the present invention includes: a cathode; an anode; and the polymer membrane described above disposed between the cathode and the anode.

The cathode and the anode each include a gas diffusion layer and a catalyst layer. The catalyst layer includes a metal catalyst which catalyzes related reactions (oxidation of hydrogen and reduction of oxygen). The catalyst layer may include at least one catalyst selected from the group consisting of platinum, ruthenium, osmium, a platinum-osmium alloy, a platinum-palladium alloy and a platinum-M alloy, wherein M includes at least one transition metal selected from the group consisting of Ga, Ti, V, Cr, Mn, Fe, Co, Ni, Cu, and Zn. Preferably, the catalyst layer includes platinum, ruthenium, osmium, a platinum-ruthenium alloy, a platinum-osmium alloy, a platinum-palladium alloy, a platinum-cobalt alloy, or a platinum-nickel alloy.

Also, a metal catalyst supported by a carrier can be used in the catalyst layer. The carrier may be carbon, for example, acetylene black or graphite, or an inorganic particle such as alumina, silica, etc. A noble metal contained in the carrier may be used as the catalyst. In this case, such a carrier may be bought in the related market or may be prepared by supporting a noble metal with a carrier.

The gas diffusion layer may be carbon paper or a carbon cloth, but is not limited thereto. In the anode and cathode, the gas diffusion layer provides support and diffuses a reaction gas towards the catalyst layer so that the reaction gas can easily approach the catalyst layer. Also, the carbon paper or the carbon cloth may be coated with a fluorine-based resin such as polytetrafluoroethylene to be hydrophobic. Such a gas diffusion layer prevents deterioration of gas diffusion caused by water while the fuel cell operates.

The anode and cathode may each further include a microporous layer to increase the gas diffusion between the gas diffusion layer and the catalyst layer. The microporous layer is formed of a compound containing a conductive material, such as carbon powder, carbon black, activated carbon, acetylene black, or the like, a binder such as polytetrafluoroethylene, and an ionomer if required.

The fuel cell of the current embodiment may be a direct methanol fuel cell (DMFC).

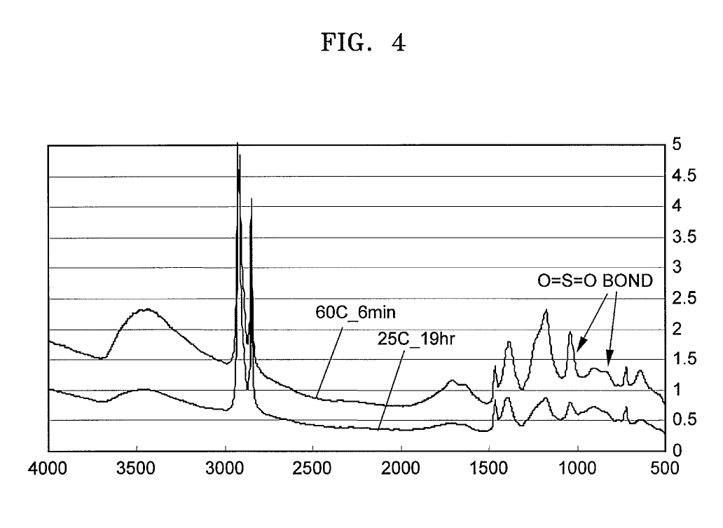

Hereinafter a DMFC according to an embodiment of the present invention will be described with reference to FIG. 3.

Referring to FIG. 3, the DMFC includes an anode 32 supplying a fuel, a cathode 30 supplying an oxidizer, and a polymer electrolyte membrane 35 interposed between the anode 32 and the cathode 30. The anode 32 can include an anode diffusion layer 22 and an anode catalyst layer 33, and the cathode 30 can include a cathode diffusion layer 23 and a cathode catalyst layer 31.

The aqueous methanol solution transferred to the anode catalyst layer 33 through the anode diffusion layer 22 decomposes into electrons, hydrogen ions, carbon dioxide, etc. The hydrogen ions are transferred to the cathode catalyst layer 31 through the polymer electrolyte membrane 35, the electrons are transferred to an external circuit, and the carbon dioxide is discharged to the outside. In the cathode catalyst layer 31, the hydrogen ions transferred from the polymer electrolyte membrane 35, the electrons supplied from the external circuit, and oxygen in air transferred from the cathode diffusion layer 23 react to form water.

The present invention will be described in greater detail with reference to the following examples. The following examples are for illustrative purposes only and are not intended to limit the scope of the invention.

### EXAMPLE 1

A polyethylene film (manufactured by Teklon) having a thickness of 20 μm and pores having an average diameter of 0.5 μm, wherein the total volume area of pores is about 70% of the total volume of the polyethylene film, was prepared as a porous polymer film. Next, the polyethylene film was impregnated with a solution for sulfonation formed of fuming sulfuric acid (SO₃ 15%) and dichloromethane in a volume ratio of 1:1.5 for 3 minutes at 60° C. Then, the result was impregnated with a 50% aqueous sulfuric acid solution for 1 minute at room temperature. The resultant product was cleaned with deionized water, and then dried at room temperature for 12 hours to prepare a polymer membrane.

### EXAMPLE 2

A polymer membrane was prepared according to Example 1, except that the impregnating of the polyethylene film at 60° C. was performed for 6 minutes.

### EXAMPLE 3

A polymer membrane was prepared according to Example 1, except that the impregnating of the polyethylene film at 60° C. was performed for 9 minutes.

### EXAMPLE 4

A polymer membrane was prepared according to Example 1, except that the impregnating of the polyethylene film at 60° C. was performed for 12 minutes.

### EXAMPLE 5

A polymer membrane was prepared according to Example 2, except that the result of impregnating the polyethylene film in the solution for sulfonation was dried at 80° C. for 12 hours using a thermostat.

### EXAMPLE 6

A polymer membrane was prepared according to Example 2, except that after impregnating the polyethylene film with the solution for sulfonation at 60° C. for 6 minutes, the result was impregnated with a NAFION™ solution (weight ratio 17%) for 1 minute. Then, the resultant product was cleaned with deionized water to prepare a polymer membrane including an ionic conductive material coated on both sides of the porous polymer film.

### COMPARATIVE EXAMPLE 1

A polymer membrane was prepared according to Example 1, except that the polyethylene film was impregnated with the solution for sulfonation at room temperature for 19 hours.

### COMPARATIVE EXAMPLE 2

A commercially available electrolyte membrane, NAFION 117 (manufactured by DuPont™) was obtained.

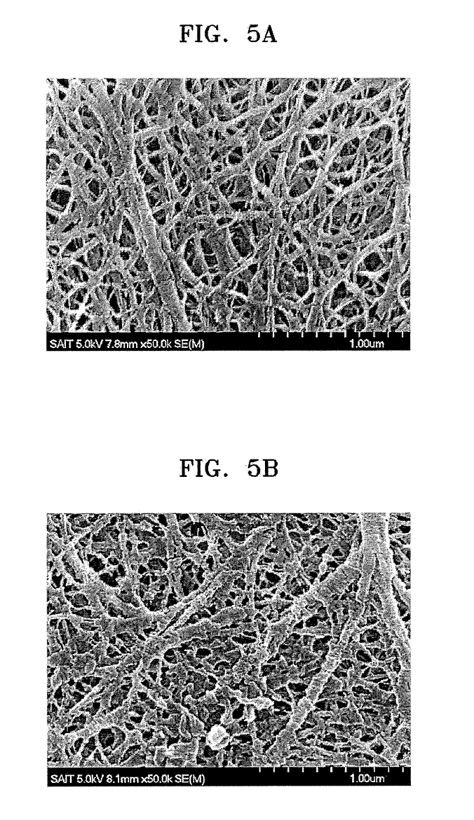

FIG. 4 is the infrared (IR) spectrum of porous polymer films prepared in Example 2 and Comparative Example 1. Referring to FIG. 4, even though sulfonation was performed in Comparative Example 1 for 19 hours, which is a remarkably long time compared to the 6 minutes of Example 2, the IR spectrum shows that the degree of sulfonation of Comparative Example 1 was insignificant compared to that of Example 2.

Also, comparing the results of Examples 2 and 5 shown in Table 1 below, when the drying temperature was increased, ionic conductivity decreased slightly while permeability remarkably decreased. Accordingly, when the drying temperature is high, properties of the polymer membrane as an electrolyte membrane are relatively excellent.

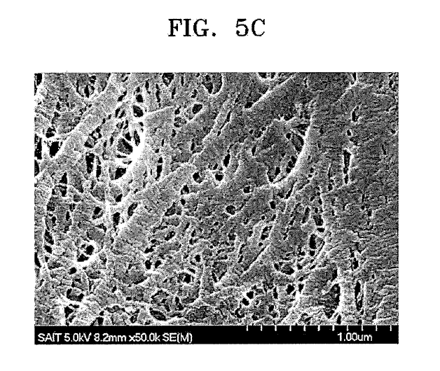

FIGS. 5A through 5C are scanning electron microscope photos of a porous polymer film before sulfuric acid solution treatment, a porous polymer film prepared in Example 2, and a porous polymer film prepared in Example 4, respectively. Referring to FIGS. 5A through 5C, as the sulfonation time increased, the size of pores of the porous polymer films decreased.

The ionic conductivity, the permeability, and the ratio of ionic conductivity to permeability of Examples 1 through 6 and Comparative Example 2 are shown in Table 1 below.

TABLE 1

| Polymer | Ionic conductivity | Permeability | Ionic conductivity/ |
|---|---|---|---|
| membrane | (S/cm) | (cm²/sec) | Permeability |
| Example 1 | 1.46 × 10⁻³ | 5.22 × 10⁻⁷ | 2.81 × 10³ |
| Example 2 | 1.61 × 10⁻³ | 3.71 × 10⁻⁷ | 4.33 × 10³ |
| Example 3 | 1.99 × 10⁻³ | 4.84 × 10⁻⁷ | 4.12 × 10³ |
| Example 4 | 3.14 × 10⁻³ | 5.64 × 10⁻⁷ | 5.57 × 10³ |
| Example 5 | 1.13 × 10⁻³ | 1.40 × 10⁻⁷ | 8.05 × 10³ |
| Example 6 | 5.70 × 10⁻² | 7.70 × 10⁻⁷ | 7.40 × 10³ |
| Comparative | 2.00 × 10⁻² | 3.70 × 10⁻⁷ | 5.40 × 10³ |
| Example 2 | | | |

As shown in Table 1, the polymer membrane according to embodiments of the present invention had good ionic conductivity like a conventional polymer membrane, such as NAFION, etc. but lower permeability.

The polymer membrane of the present invention can be prepared easily and economically, has excellent ionic conductivity, and effectively reduces crossover in a fuel cell.

While the present invention has been shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A polymer membrane, comprising a porous polymer film having sulfonated pores.

2. The polymer membrane of claim 1, wherein the porous polymer film is a porous polyolefin film.

3. The polymer membrane of claim 2, wherein the porous polyolefin film is a porous polyethylene film, a porous polypropylene film, or a mixed film thereof.

4. The polymer membrane of claim 1, wherein the average diameter of the sulfonated pores is in the range of 10 nm to 10 μm, and the total volume of the sulfonated pores is in the range of 10 to 90% of the total volume of the porous polymer film.

5. The polymer membrane of claim 1, wherein the thickness of the polymer membrane is in the range of 0.5 to 2,000 μm.

6. The polymer membrane of claim 1, wherein the sulfonated pores comprise an alkane sulfonic acid group of Formula 1, a beta-sulfone group of Formula 2, an alkene sulfonic acid group of Formula 3 or 4, a gamma-sulfone group of Formula 5, or a delta-sulfone group of Formula 6:

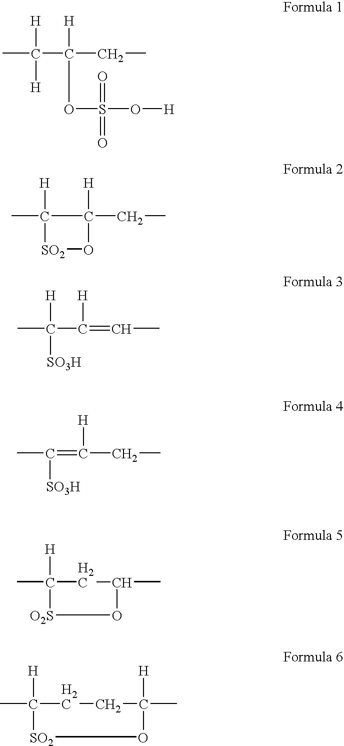

7. The polymer membrane of claim 1, further comprising an ionic conductive material coated on one side or both sides of the porous polymer film.

8. The polymer membrane of claim 7, wherein the ionic conductive material comprises at least one material selected from the group consisting of sulfonated perfluorinated polymer, sulfonated polysulfone, sulfonated polystyrene, sulfonated polyetheretherketone, sulfonated polybenzimidazole, sulfonated polyimide, and sulfonated polyphosphazene.

9. A method of preparing a polymer membrane, the method comprising:
preparing a porous polymer film;
impregnating the porous polymer film with a solution for sulfonation; and
cleaning and drying the resultant porous polymer film.

10. The method of claim 9, wherein the porous polymer film is a porous polyolefin film.

11. The method of claim 10, wherein the porous polyolefin film is a porous polyethylene film, a porous polypropylene film, or a mixed film thereof.

12. The method of claim 9, wherein the average diameter of the sulfonated pores is in the range of 10 nm to 10 μm, and the total volume of the sulfonated pores is in the range of 10 to 90% of the total volume of the porous polymer film.

13. The method of claim 9, wherein the solution for sulfonation comprises sulfuric acid with a concentration of 90% or greater, fuming sulfuric acid, or chlorosulfonic acid.

14. The method of claim 13, wherein the solution for sulfonation further comprises a supporting solvent selected from the group consisting of dichloromethane, dichloroethane, chloroform, and mixtures thereof.

15. The method of claim 14, wherein the amount of the solution for sulfonation is in the range of 10 to 500 parts by weight based on 100 parts by weight of the supporting solvent.

16. The method of claim 9, further comprising impregnating the resultant porous polymer film in an aqueous sulfuric acid solution.

17. The method of claim 9, further comprising, after the impregnating of the porous polymer film with the solution for sulfonation or the impregnating the resultant porous polymer film in the aqueous sulfuric acid solution, coating an ionic conductive material on the surface of the porous polymer film.

18. The method of claim 16, wherein the concentration of the aqueous sulfuric acid solution is in the range of 30 to 50%.

19. A fuel cell, comprising:
a cathode;
an anode; and
the polymer membrane of claim 1 disposed between the cathode and the anode.
